(19) United States
(12) Patent Application Publication
(10) Pub. No.: US 2026/0295837 A1
(43) Pub. Date: Oct. 1, 2026

(54) COLLISION-FREE ROBOT PATHS

(71) Applicant: KUKA Deutschland GmbH, Augsburg (DE)

(72) Inventors: Jonas Schwinn, Augsburg (DE); Dominik Joho, Augsburg (DE)

(73) Assignee: KUKA Deutschland GmbH, Augsburg (DE)

(21) Appl. No.: 19/476,894

(22) PCT Filed: Feb. 28, 2024
(86) PCT No.: PCT/EP2024/055095

§ 371 Date: Oct. 20, 2025

(30) Foreign Application Priority Data
Apr. 24, 2023 (DE) 10 2023 203 751.3

(51) Int. Cl. B25J 9/16; G06V 10/70; G06V 20/58

(52) U.S. Cl. CPC B25J 9/1666; B25J 9/163; B25J 9/1671; B25J 9/1697; G06V 10/70; G06V 20/58; G05B 2219/35009; G05B 2219/39001; G05B 2219/40476

(57) ABSTRACT

A method for planning a path of a robot includes providing alternative target poses of the robot; providing environmental data which specify a geometry of an environment of the robot; evaluating the alternative target poses using a machine-learned prediction for a collision-free path for the particular target pose on the basis of these environmental data; selecting one of the alternative target poses as a target pose candidate on the basis of this evaluation; and carrying out path planning on the basis of this target pose candidate. A method for machine learning of the prediction includes providing alternative learning poses of the robot; providing in particular alternative environmental learning data which specify a geometry of an environment of the robot; carrying out path planning on the basis of these learning poses and environmental learning data; and machine learning of the prediction on the basis of the learning poses, environmental learning data and results of the path planning.

### CROSS-REFERENCE TO RELATED APPLICATIONS

This application is a national phase application under 35 U.S.C. § 371 of International Patent Application No. PCT/EP2024/055095, filed Feb. 28, 2024 (pending), which claims the benefit of priority to German Patent Application No. DE 10 2023 203 751.3, filed Apr. 24, 2023, the disclosures of which are incorporated by reference herein in their entirety.

### TECHNICAL FIELD

The present invention relates to a method for planning a path of a robot using a machine-learned prediction for a collision-free path, to a method for machine learning of the prediction, and to a system and a computer program or computer program product for carrying out a method described herein.

### BACKGROUND

A common requirement for robots is to assume one or more target poses, for example to grip or place an object, to machine a workpiece, or the like.

Often, several alternative target poses are available, for example alternative grips, alternative objects, alternative placement or processing poses, or the like.

If it is determined (only) during path planning for an (already) selected alternative target pose that the path planned for these target poses (potentially) leads to a collision of the robot or if no collision-free path is found, the entire path planning must be repeated for another of the alternative target poses. If several target poses are tried and rejected in this way, this significantly increases the time required.

### SUMMARY

An object of one embodiment of the present invention is to improve the planning or traveling of robot paths, preferably to reduce, preferably to avoid, one or more of the aforementioned disadvantages or problems.

This object is achieved by a method, a system, and a computer program or computer program product for carrying out a method as described herein.

According to one embodiment of the present invention, a method for planning a path of a robot comprises the following steps:
providing alternative target poses of the robot;
providing environmental data which specify a geometry of an environment of the robot;
evaluating this/these alternative target pose(s) using a machine-learned prediction for a, in a development for finding a, collision-free path for the particular target pose on the basis of these environmental data, in particular on the basis of these environmental data of the particular target pose;
selecting one of the alternative target poses as a target pose candidate on the basis of this evaluation; and
carrying out path planning on the basis of this target pose candidate.

One embodiment of the present invention is based on the concept of first determining or selecting, in a multi-stage method, a target pose candidate that is promising, in particular more promising, preferably the most promising or one of the most promising, with regard to a, in particular finding a, collision-free path, using or on the basis of an (evaluation using a) machine-learned prediction and then carrying out path planning on the basis of this or these most promising target pose candidate(s).

In comparison with trying out target pose candidates without ab initio consideration of collision probabilities, this can save statistically significant time in one embodiment. In comparison with one-step determination of possible collision-free paths by means of an artificial neural network, in one embodiment the machine-learned prediction for (finding) a collision-free path can be better trained and/or work more reliably and/or faster. Additionally or alternatively, this, in particular the path planning in a second stage, can increase the reliability of no collision occurring on the planned path.

In one embodiment, the robot comprises at least one robot arm. Additionally or alternatively, the robot, in particular the robot arm, comprises in one embodiment at least three, in particular at least six, in one embodiment at least seven, joints or (movement) axes, in particular joints or axes that are actuated or adjustable by drives of the robot and/or rotary joints or axes. The invention is advantageous for such robots in particular because of the kinematics, use conditions and possibilities of collision.

Providing alternative target poses comprises, in one embodiment, specifying alternative target poses, in a development on the basis of a user input and/or in an at least partially automated manner, and in one embodiment on the basis of environmental data of the robot, in particular environmental detection and/or processing data, for example (detected) objects to be gripped, possible storage locations, workpieces to be machined, robot-guided tools or the like.

Additionally or alternatively, providing may in particular comprise retrieving or loading stored alternative target poses. As a result, in one embodiment, more promising or more appropriate target poses can be used in advance and/or the method can be accelerated.

A pose within the meaning of the present invention comprises, in one embodiment, an attitude of the robot, in particular of its joints, and/or an in particular one-, two- or three-dimensional position, and/or an in particular one-, two- or three-dimensional orientation, in particular of at least one robot-fixed reference, preferably of an end effector, TCP or the like.

Providing environmental data which specify a geometry of an environment of the robot comprises, in one embodiment, the sensory detection of the environment, in a development using at least one camera, in particular a stationary or robot-guided camera, and/or data processing, in particular filtering, transforming or the like, of environmental data and/or retrieving or loading of stored environmental data. In one embodiment, the environmental data provided are based on a sensory detection of an environment of the robot, in particular using at least one in particular stationary or robot-guided camera, and/or a theoretical model of the environment, for example a CAD model of a robot cell or the like. The reliability of avoiding a collision can thus be improved in one embodiment.

In one embodiment, a machine-learned prediction for a collision-free path for a target pose, in particular for finding a collision-free path for the target pose, determines or delivers, on the basis of environmental data (and the target pose), a value, preferably a binary value, a probability value or the like, which depends on whether it is likely or with what probability a collision-free path for the target pose can be (successfully) planned, or whether it is likely or with what probability a collision will occur on a path planned for the target pose. In one embodiment, the machine-learned prediction F maps different input data Xᵢ, each of which comprises (the) environmental data c and one of the alternative target poses xᵢ, on output data Yᵢ, which in one embodiment binarily indicate whether it is likely a collision-free path can be (successfully) planned for this target pose xᵢ or whether it is likely a or no collision will occur on a path planned for this target pose xᵢ, or indicate a probability thereof, for example between zero and one or the like (F(Xᵢ)=Yᵢ).

As already explained, in one embodiment, the or one of the alternative target poses is selected as the target pose candidate for which the machine-learned prediction predicts that it is likely a collision-free path can be (successfully) planned or that it is likely no collision will occur on a planned path or that the probability thereof is higher than for one or more other of the alternative target poses, preferably is the highest. If two or more of the alternative target poses are evaluated equally, one of these target poses is selected randomly or according to further criteria, for example a predetermined prioritization or the like.

Preferably, the planning of a robot path, which is subsequently checked for collisions of the robot, is carried out in a similar way for the machine learning of the prediction and the carrying out of path planning on the basis of the selected target pose candidate. In one embodiment, this can reduce the probability of failed attempts.

Carrying out path planning comprises, in one embodiment, in particular in a first stage, planning at least one path of the robot and, in particular in a second stage, checking this planned path, in a development the target pose and/or one or more (other) poses of the robot along the path, for collisions of the robot, in particular with itself and/or the environment. In this case, this planning of a path can in particular comprise predetermining one or more path points, in particular (further) poses of the robot along the path, and in one embodiment connecting these path points, for example by means of interpolation. This allows the path planning to be carried out more quickly in one embodiment.

In one embodiment, when carrying out path planning, a (first) path of the robot is first planned and checked for collisions of the robot and, if a collision is detected, another path of the robot is planned one or more times and checked for collisions of the robot, preferably until a termination criterion, for example a predetermined maximum number of attempts or the like, is met. As a result, in one embodiment, a path is first attempted, possibly several times (in different ways), for a selected target pose candidate and then checked for collisions in each case, and a new target pose candidate is selected only if a collision is (also) detected in several of these (differently) planned paths for this target pose candidate. In one embodiment, a prioritization within the target poses that is not based on predicted collisions can thus advantageously be taken into consideration. For example, for a first gripping position for which the machine-learned prediction has predicted a collision-free path and the carrying out of path planning has resulted in a first path for which a collision was detected during the check for collisions (despite or contrary to the prediction), one or more other paths can first be planned and also checked for collisions before a different gripping pose is selected as the new target pose candidate instead of this first gripping pose, for example if the first gripping pose can be reached more quickly by the robot or is closer to a storage location or the like.

In another embodiment, when carrying out path planning, only one path of the robot is planned and checked for collisions of the robot and, if a collision is detected, a new target pose candidate is selected instead of this target pose candidate and new path planning is carried out therefor. Thus, in one embodiment, when a collision is detected for a selected target pose candidate, a new target pose candidate is selected next. In one embodiment, this can advantageously reduce the probability of failed attempts.

In one embodiment, carrying out path planning comprises attempting to plan a path of the robot (ab initio) while avoiding collisions of the robot, in particular using a collision-free path planner. For example, starting from the target pose, the path planner can attempt to plan a path in a space determined to be collision-free, in particular to determine such a path, to successively determine collision-free path points on the way to a desired path end, or the like. In one embodiment, this can reduce the probability of failed attempts.

In one embodiment, path planning is carried out on the basis of the provided environmental data; in a development, the planned path(s) is/are checked for collisions of the robot on the basis of the environmental data or an attempt is made, on the basis of the environmental data, to plan a path of the robot (ab initio) while avoiding collisions of the robot, in particular using a collision-free path planner.

In one embodiment, the method comprises the following steps, which may be repeated multiple times in a development:
selecting another of the alternative target poses as a new target pose candidate on the basis of the evaluation if a termination condition is met during the preceding carrying out of the path planning; and
carrying out path planning on the basis of this new target pose candidate.

The termination condition may in particular comprise that no path was able to be planned while avoiding collisions, in particular within a predetermined time or maximum number of attempts or the like, or that a collision was detected when checking a planned path or that a termination criterion of this path planning, for example a predetermined maximum number of attempts or the like, has been met.

Thus, in one embodiment, if path planning for a target pose candidate fails, in particular if no path was able to be planned therefor while avoiding collisions or if a collision was detected when checking a planned path or several planned paths, a new target pose candidate is selected instead and path planning is carried out again on the basis of this new target pose candidate. In one embodiment, this can reduce the probability of failed attempts.

In one embodiment, the alternative target poses comprise start poses of the robot, end poses of the robot and/or working poses of the robot, in a development pick-up poses, in particular gripping poses of the robot and/or delivery poses of the robot. Additionally or alternatively, in one embodiment, a or the (particular) path of the robot comprises the (particular) target pose, in particular the (particular) target pose candidate.

Thus, a planned path can in particular be a path for gripping one of several objects, for gripping an object in one of several gripping positions, a path for moving to one of several storage positions, a path for moving to or from one or more machining positions, or the like. The invention is advantageous for this in particular because of the kinematics, use conditions and possibilities of collision.

In one embodiment, the environmental data comprise surface points and/or images, in a development depth images and/or from a predetermined perspective, preferably from a perspective of a camera with which the environment is captured or using which the environmental data are generated, and/or an end effector, preferably a gripper, of the robot or a perspective shifted relative to this end effector perspective, in particular in the gripping direction.

Surface points are particularly suitable for machine-learned predictions, while images can advantageously represent the environment and/or can be processed (more) directly.

In one embodiment, the robot travels on the (successfully) planned path, in particular the path (successfully) planned while avoiding collisions of the robot or the planned path for which no collision was detected during checking. Accordingly, in one embodiment, the present invention relates to a method for (planning and) traveling on a (planned) path with the robot and to a corresponding system.

According to one embodiment of the present invention, a method for machine learning of a prediction based on environmental data (and a target pose of a robot) for a collision-free path for the target pose comprises the following steps:
predetermining alternative learning poses of the robot;
providing, in one embodiment alternative, environmental learning data which specify a geometry of an environment of the robot;
carrying out path planning on the basis of these learning poses and environmental learning data; and
machine learning of the prediction on the basis of the learning poses, environmental learning data and results of the path planning.

The machine-learned prediction can be carried out in particular using at least one artificial neural network or at least one other model or principle of artificial intelligence or machine learning, in particular for classification or regression. As explained above, in one embodiment, the machine-learned prediction F maps input data Xᵢ, each of which comprises environmental data c and a target pose xᵢ, on output data Yᵢ (F(Xᵢ)=Yᵢ) and accordingly, in one embodiment, is machine-learned, in particular trained, on the basis of input learning data X′ᵢ, each of which comprises environmental learning data c′ or c′ᵢ (alternative environmental learning data) and a learning pose xᵢ, and data Yᵢ, which in each case are based on a result of path planning carried out for this learning pose and environmental learning data, in one development depend on whether the path planning was carried out successfully or not, and in one development each indicate a corresponding probability (if, for example, a stochastic path planner is used for data collection, several results can arise for a pose; for example, the planner could find a path in 6 out of 10 cases, in which case the corresponding data value would be set to 0.6). By taking into consideration different environmental learning data c′ᵢ, in one embodiment the machine-learned prediction can be used (more) successfully in different environments.

In one embodiment, the environmental learning data are preferably created using one or more, in particular numerical, simulations, in particular alternative environmental learning data are created using simulations of different environments. Additionally or alternatively, in one embodiment, the path planning on the basis of the results of which the prediction is machine-learned is carried out using one or more, in particular numerical, simulations; in a development, path planning is carried out using simulations of different environments or on the basis of alternative environmental learning data or alternative simulated or virtual environments. Particularly preferably, during the carrying out of path planning operations and the machine learning of the prediction on the basis of the results of these path planning operations, the same simulated or virtual environments are used as a basis or environmental learning data are created for one or more virtual environments using a simulation, path planning is carried out on the basis of these environmental learning data and the result thereof is linked to these environmental learning data or this result and these environmental learning data are used for machine learning of the prediction. In other words, the prediction for target poses and different virtual environments machine-learns to predict the success of planning a collision-free path for this target pose in this virtual environment.

This allows the prediction to be machine-learned (more) quickly and/or the prediction quality thereof to be improved.

The features explained above with reference to planning a path, in particular that carrying out path planning comprises planning at least one path of the robot and checking this planned path for collisions of the robot or attempting to plan a path of the robot while avoiding collisions of the robot, can additionally or alternatively also be realized in the machine learning of the prediction, and so reference is made to the above explanations in this regard. Accordingly, in one embodiment, the environmental learning data additionally or alternatively comprise surface points and/or images, in particular depth images and/or from a predetermined perspective. In a development, surface points are first generated, preferably using at least one simulation, and from these at least one image, in particular a depth image and/or from a predetermined perspective, preferably from a perspective of a camera with which, in one embodiment, the environment is captured (for planning the path) or using which, in one embodiment, the environmental data are generated (for planning the path), and/or an end effector, preferably a gripper, of the robot or a perspective shifted relative to this end effector perspective, in particular in the gripping direction. It is particularly advantageous if environmental data and environmental learning data are similar, in particular both comprise surface points or both comprise images, in particular depth images and/or from the same perspective, and/or if the carrying out of path planning on the basis of a target pose candidate and the carrying out of path planning on the basis of a learning pose are similar, in particular both comprise preferably similar planning of at least one path of the robot and preferably similar checking of this planned path for collisions of the robot or a preferably similar attempt to plan a path of the robot while avoiding collisions of the robot, since this allows the machine-learned prediction to better predict the conditions when planning the path.

According to one embodiment of the present invention, a system for planning, in a development for traveling on, a path of a robot and/or for machine learning of a prediction (based on environmental data and a target pose of the robot) for a collision-free path (for the target pose) of a robot is configured, in particular as hardware and/or software, in particular as a program, to carry out a method described herein.

According to one embodiment of the present invention, a system comprises:
means for providing alternative target poses of the robot;
means for providing environmental data which specify a geometry of an environment of the robot;
means for evaluating the alternative target poses using a machine-learned prediction for a collision-free path for the particular target pose on the basis of these environmental data;
means for selecting one of the alternative target poses as a target pose candidate on the basis of this evaluation; and
means for carrying out path planning on the basis of this target pose candidate.

In one embodiment, the system or the means thereof comprises:
means for selecting, in particular multiple times, another of the alternative target poses as a new target pose candidate on the basis of the evaluation if a termination condition is met during the preceding carrying out of the path planning; and
means for carrying out path planning on the basis of this new target pose candidate.

In one embodiment, the system or the means thereof comprises:
means for traveling on the planned path with the robot.

According to one embodiment of the present invention, a system comprises:
means for specifying alternative learning poses of the robot;
means for providing in particular alternative environmental learning data which specify a geometry of an environment of the robot;
means for carrying out path planning on the basis of these learning poses and environmental learning data; and
means for machine learning of the prediction on the basis of the learning poses, environmental learning data and results of the path planning.

In one embodiment, the system or the means thereof comprises:
means for creating the environmental learning data using at least one simulation; and/or
means for carrying out the path planning for machine learning using at least one simulation.

In one embodiment, the or at least one of the system(s) or the means thereof for carrying out path planning comprises:
means for planning at least one path of the robot; and
means for checking this planned path for collisions of the robot.

In one embodiment, the or at least one of the system(s) or the means thereof for carrying out path planning comprises:
means for attempting to plan a path of the robot while avoiding collisions.

A system and/or a means within the meaning of the present invention may be designed as hardware and/or software, and in particular may comprise at least one, in particular digital, processing unit, in particular a microprocessor unit (CPU), graphics card (GPU), or the like, which is preferably data-connected or signal-connected to a memory system and/or bus system, and/or one or more programs or program modules. The processing unit may be designed to process commands that are implemented as a program stored in a memory system, to acquire input signals from a data bus and/or to deliver output signals to a data bus. A memory system may comprise one or more, in particular different, memory media, in particular optical, magnetic, solid-state, and/or other non-volatile media. The program may be provided in such a way that it embodies or is capable of executing the methods described herein, so that the processing unit can execute the steps of such methods and thus, in particular, plan a path of a robot, in a development control the robot to travel on the path, and/or machine-learn a prediction (based on environmental data and a target pose of the robot) for a collision-free path (for the target pose) of a robot. In one embodiment, a computer program product may comprise, in particular be, an in particular computer-readable and/or non-volatile, memory medium for storing a program or instructions or with a program stored thereon or with instructions stored thereon. In one embodiment, execution of said program or said instructions by a system or controller, in particular a computer or an arrangement of a plurality of computers, causes the system or controller, in particular the computer(s), to execute a method described herein or one or more steps thereof, or the program or instructions are configured to do so.

In one embodiment, one or more, in particular all, steps of the method are fully or partially computer-implemented or one or more, in particular all, steps of the method are fully or partially automated, in particular by the system or the means thereof. In one embodiment, a system comprises the robot.

In one embodiment, at least one of the path planning operations mentioned here is carried out using or by means of a stochastic path planner(s). In one embodiment, this can improve the machine learning of the prediction and/or the carrying out of path planning on the basis of target pose candidates, in particular can increase convergence and/or velocity.

Further advantages and features can be found in the claims and the exemplary embodiments.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts an exemplary system for carrying out the method of FIG. 2 according to one embodiment of the present invention; and

FIG. 2 illustrates an exemplary method for machine learning of a prediction, planning a path using the machine-learned prediction and traveling on the planned path with a robot according to one embodiment of the present invention.

### DETAILED DESCRIPTION

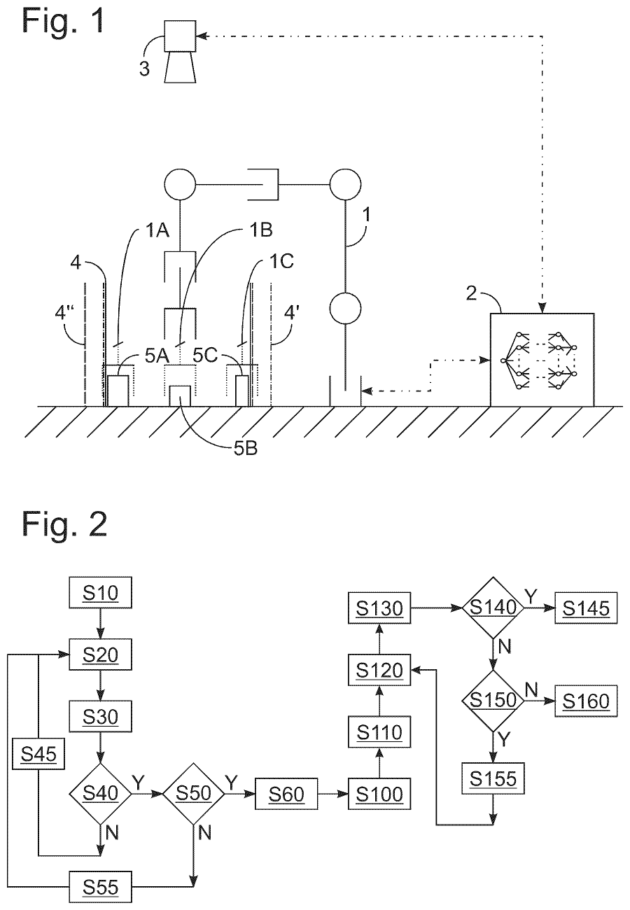

FIG. 1 shows a robot 1, a robot controller 2, a camera 3 and an environment indicated by a container 4, away from which the robot 1 is to transport objects 5A-5C.

For this purpose, according to a method for machine learning of a prediction, which is based on environmental data and a target pose of a robot, for a collision-free path for the target pose according to one embodiment of the present invention, in a step S10, various alternative environmental learning data are provided using simulations of various environments, of which two simulated or virtual environments 4′, 4″ are indicated by dashed or dash-dotted lines in FIG. 1, and one of the simulated or virtual environments or the corresponding environmental learning data is selected. These environmental learning data can, for example, be surface point clouds or image data that are rendered therefrom and correspond to a depth image of the camera 3.

For or in the selected simulated or virtual environment, alternative learning poses of the robot for gripping objects are specified in step S10, of which three learning poses 1A-1C are indicated in FIG. 1 by dotted gripper poses, and one of these is selected.

In steps S20, S30, path planning is carried out for the selected learning pose and the selected environmental learning data or simulated or virtual environment on the basis of this selected learning pose and environmental learning data and the result thereof is stored.

In one embodiment, in step S20, a path is first planned on the basis of the learning pose, and in step S30, this planned path is checked for collisions of the robot using a simulation on the basis of the environmental learning data, and whether or not a collision was detected in the planned path is stored as the result of this path planning in step S30.

In another embodiment, in step S20, an attempt is made to plan a path of the robot while avoiding collisions of the robot using a simulation on the basis of the environmental learning data or in the selected simulated or virtual environment, and in step S30, whether or not a path was able to be planned while avoiding collisions is stored as the result of this path planning.

In step S40, it is checked whether path planning has already been carried out for all learning poses. If this is not the case (S40: “N”), in a step S45 one of the learning poses specified in step S10 for which no path planning has yet been carried out is selected and steps S20, S30 are carried out again.

Otherwise (S40: “Y”), in a step S50 it is checked whether path planning has been carried out for all simulated or virtual environments or alternative environmental learning data for the learning poses. If this is not the case (S50: “N”), in a step S55 a simulated or virtual environment or the corresponding environmental learning data for which no path planning has yet been carried out are selected and steps S20, S30 are carried out again.

After processing all environmental learning data (S50: “Y”), a prediction is machine-learned in a step S60 on the basis of the learning poses, environmental learning data and results of the path planning. Of course, this can also be carried out while repeating steps S20-S50.

According to a method for planning a path of the robot, alternative target poses of the robot and environmental data specifying a geometry of an environment of the robot are provided in a step S100. For example, the camera 3 can capture the real environment 4 and generate the environmental data therefrom and possible target poses for gripping the various objects 5A-5C can be predetermined.

In a step S110, the alternative target poses are evaluated using the machine-learned prediction, and on the basis of this evaluation, the or a target pose for which the machine-learned prediction predicts successful planning of a path without collisions or the highest probability of successful planning of a path without collisions is selected as the target pose candidate.

In steps S120, S130, path planning is then carried out analogously to steps S20, S30 described above, wherein the path planning is carried out on the basis of this target pose candidate instead of a learning pose and on the basis of the environmental data instead of the environmental learning data.

Accordingly, in one embodiment, in step S120 a path is first planned on the basis of the target pose candidate, and this planned path is checked for collisions of the robot in step S130 on the basis of the environmental data. In another embodiment, in step S120, an attempt is made to plan a path of the robot on the basis of the environmental data while avoiding collisions of the robot, and step S130 in FIG. 2 is omitted or step S140 follows step S120.

In step S140, it is checked whether the path planning was successful. If this is the case (S140: “Y”), the planned path is traveled on with the robot 1 in a step S145 and the method is ended. Step S145 may also be omitted or may (only) comprise saving the planned path for further, in particular later, use.

If the path planning was not successful (S140: “N”), it is checked whether further target pose candidates are available. If this is the case (S150: “Y”), in a step S155, on the basis of the evaluation, the or a target pose for which the machine-learned prediction (also) predicts successful planning of a path without collisions or the highest probability of successful planning of a path without collisions among the remaining target poses for which steps S120-S140 have not yet been carried out is selected as the new target pose candidate.

Steps S120-S140 are carried out again for this new target pose candidate.

If all target poses have been tried without successfully planning a path without collisions (S150: “N”), an error message is output and the method is also ended or appropriate countermeasures are taken, for example changing the arrangement of the objects 5A-5C using the robot 1 or the like (FIG. 2: step S160).

FIG. 1 clearly illustrates a basic concept of the present invention: with reference to the simulated or virtual environments 4′, 4″ or the corresponding alternative environmental learning data, a prediction is machine-learned which predicts for edge positions that successful path planning is not possible or not very (less) likely. Accordingly, when planning the path for the detected environment 4, the pose for gripping the object 5B is evaluated as the most promising candidate and the path planning is carried out therefor.

Although exemplary embodiments have been explained in the preceding description, it is pointed out that a large number of modifications is possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### List of Reference Signs

1 robot
1A-1C target/learning poses for gripping an object
2 robot controller
3 camera
4 container (environment)
4′; 4″ virtual/simulated environment
5A-5C object

What is claimed is:

1. Method for planning a path of a robot (1), comprising the following steps:
providing (S100) alternative target poses of the robot;
providing (S100) environmental data which specify a geometry of an environment of the robot;
evaluating (S110) the alternative target poses using a machine-learned prediction for a collision-free path for the particular target pose on the basis of these environmental data;
selecting (S110) one of the alternative target poses as a target pose candidate on the basis of this evaluation; and
carrying out (S120, S130) path planning on the basis of this target pose candidate.

2. Method according to claim 1, characterized in that carrying out path planning on the basis of the target pose candidate comprises planning (S120) at least one path of the robot and checking (S130) this planned path for collisions of the robot.

3. Method according to claim 1, characterized in that carrying out path planning on the basis of the target pose candidate comprises attempting (S120) to plan a path of the robot while avoiding collisions of the robot.

4. Method according to claim 1, characterized by the following steps, which are in particular repeated multiple times:
selecting (S155) another of the alternative target poses as a new target pose candidate on the basis of the evaluation if a termination condition is met during the preceding carrying out of the path planning; and
carrying out path planning on the basis of this new target pose candidate.

5. Method according to claim 1, characterized in that the alternative target poses comprise start poses, end poses and/or working poses, in particular pick-up and/or delivery poses, of the robot.

6. Method according to claim 1, characterized in that the environmental data comprise surface points and/or images, in particular depth images and/or from a predetermined perspective.

7. Method according to claim 1, characterized in that the prediction is machine-learned in accordance with a method according to any of the following claims and/or the robot travels on the planned path (S145).

8. Method for machine learning of a prediction, which is based on environmental data and a target pose of a robot (1), for a collision-free path for the target pose, comprising the following steps:
predetermining (S10) alternative learning poses of the robot;
providing (S10) in particular alternative environmental learning data which specify a geometry of an environment of the robot;
carrying out (S20, S30) path planning on the basis of these learning poses and environmental learning data; and
machine learning (S60) of the prediction on the basis of the learning poses, environmental learning data and results of the path planning.

9. Method according to claim 8, characterized in that the environmental learning data are created using at least one simulation and/or comprise surface points and/or images, in particular depth images and/or from a predetermined perspective, and/or the path planning is carried out using at least one simulation.

10. Method according to claim 8, characterized in that carrying out path planning on the basis of a learning pose comprises planning (S20) at least one path of the robot and checking (S30) this planned path for collisions of the robot.

11. Method according to claim 8, characterized in that carrying out path planning on the basis of a learning pose comprises attempting (S20) to plan a path of the robot while avoiding collisions of the robot.

12. System for planning, in particular traveling on, a path of a robot (1) and/or for machine learning of a prediction for a collision-free path of a robot, wherein the system is configured to carry out a method according to claim 1 and/or comprises:
means for providing alternative target poses of the robot;
means for providing environmental data which specify a geometry of an environment of the robot;
means for evaluating the alternative target poses using a machine-learned prediction for a collision-free path for the particular target pose on the basis of these environmental data;
means for selecting one of the alternative target poses as a target pose candidate on the basis of this evaluation; and
means for carrying out path planning on the basis of this target pose candidate and/or comprises
means for specifying alternative learning poses of the robot;
means for providing in particular alternative environmental learning data which specify a geometry of an environment of the robot;
means for carrying out path planning on the basis of these learning poses and environmental learning data; and
means for machine learning of the prediction on the basis of the learning poses, environmental learning data and results of the path planning.

13. Computer program or computer program product, wherein the computer program or computer program product contains instructions, in particular stored on a computer-readable and/or non-volatile storage medium, which, when executed by one or more computers or a system, cause the computer(s) or system to carry out a method according to claim 1.
